(19) United States
(12) Patent Application Publication
(10) Pub. No.: US 2013/0265915 A1
(43) Pub. Date: Oct. 10, 2013

(54) SCHEDULER SYSTEM FOR SIMULTANEOUS TRANSMIT AND RECEIVE

(71) Applicants: Yang-Seok Choi, Portland, OR (US); Xiangying Yang, Portland, OR (US); Muthaiah Venkatachalam, Beaverton, OR (US)

(72) Inventors: Yang-Seok Choi, Portland, OR (US); Xiangying Yang, Portland, OR (US); Muthaiah Venkatachalam, Beaverton, OR (US)

(21) Appl. No.: 13/995,161

(22) PCT Filed: Sep. 30, 2011
(86) PCT No.: PCT/US11/54188

§ 371 Date: Jun. 17, 2013

(51) Int. Cl. H04B 1/56

(52) U.S. Cl. CPC H04B 1/56
USPC 370/280

(57) ABSTRACT

A wireless communication system and method schedules a beginning of an uplink transmission from a wireless device to a network transceiver with a first predetermined period of time after an end of a downlink transmission from the network transceiver device to the wireless device is scheduled. The uplink transmission and the downlink transmission comprise the same carrier frequency. The first predetermined period of time is related to a time required for the wireless device to switch from between receive and transmit modes. A beginning a downlink transmission from the network transceiver to the wireless device is scheduled with a second predetermined period of time after an end of an uplink transmission from the wireless device to the network transceiver is scheduled. The second predetermined period of time is related to a time required for the wireless device to switch between transmit and receive modes.

### BACKGROUND

Simultaneous Transmit and Receive (STR) allows transmit and receive operations to occur simultaneously at the same radio frequency (RF) carrier. Accordingly, STR can increase channel capacity to up to twice that of a conventional Time Division Duplexing (TDD) based and/or Frequency Division Duplexing (FDD) based channel because the downlink (DL) and uplink (UL) channels share the same RF carrier both in time and in frequency resources.

### DESCRIPTION OF THE DRAWING FIGURES

Claimed subject matter is particularly pointed out and distinctly claimed in the concluding portion of the specification. Such subject matter may, however, be understood by reference to the following detailed description when read with the accompanying drawings in which:

FIG. 1 depicts a temporal relationship diagram for Simultaneous Transmit and Receive (STR) for a portion of an exemplary downlink radio frame and a portion an exemplary uplink radio frame of a channel according to the subject matter disclosed herein;

FIG. 2 shows a block diagram of the overall architecture of a Third Generation Partnership Project Long Term Evolution (3GPP LTE) network including network elements and standardized interfaces and that utilizes a simultaneous transmit and receive according to the subject matter disclosed herein; and

FIGS. 3 and 4 depict radio interface protocol structures between a UE and an eNodeB that are based on a 3GPP-type radio access network standard and that utilize a simultaneous transmit and receive technique in accordance with the subject matter disclosed herein;

FIG. 5 depicts functional block diagram of an information-handling system 500 that utilizes a simultaneous transmit and receive technique according to the subject matter disclosed herein; and

FIG. 6 depicts a functional block diagram of a wireless local area or cellular network communication system depicting one or more network devices utilizing a simultaneous transmit and receive technique according to the subject matter disclosed herein.

It will be appreciated that for simplicity and/or clarity of illustration, elements illustrated in the figures have not necessarily been drawn to scale. For example, the dimensions of sonic of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

In the following description and/or claims, the terms coupled and/or connected, along their derivatives, may be used. In particular embodiments, connected may be used to indicate that two or more elements are in direct physical and/or electrical contact with each other. Coupled may mean that two or more elements are in direct physical and/or electrical contact. Coupled may, however, also mean that two or more elements may not be in direct contact with each other, but yet may still cooperate and/or interact with each other. For example, “coupled” may mean that two more elements do not contact each other but are indirectly joined together via another element or intermediate elements. Finally, the terms “on,” “overlying,” and “over” may be used in the following description and claims “On,” “overlying,” and “over” may be used to indicate that two or more elements are in direct physical contact with each other. “Over” may, however, also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other. As used herein, the word “exemplary” means “serving as an example, instance, or illustration,” Any embodiment described herein as “exemplary” is not to be construed as necessarily preferred or advantageous over other embodiments.

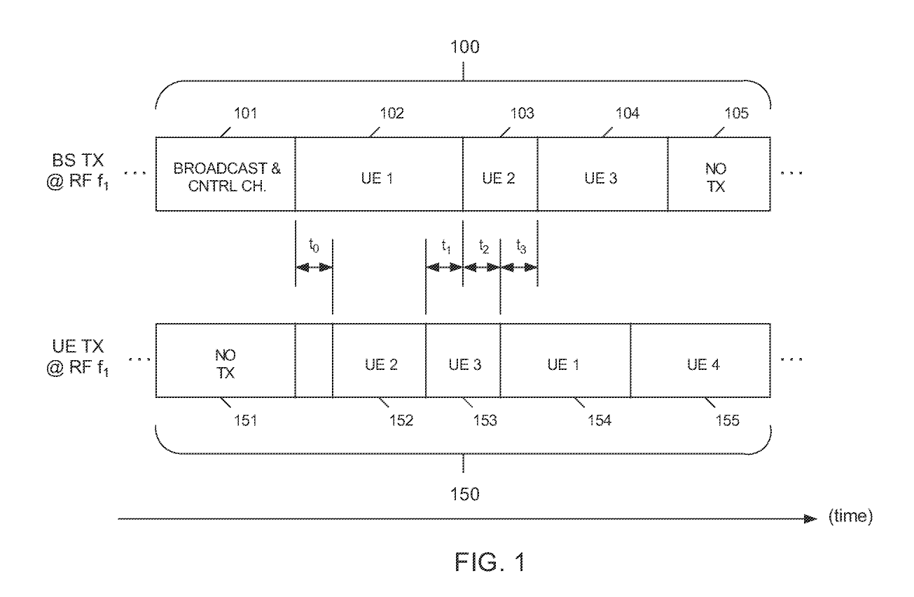

FIG. 1 depicts a temporal relationship diagram for Simultaneous Transmit and Receive (STR) for a portion of an exemplary downlink radio frame and a portion an exemplary uplink radio frame of a channel according to the subject matter disclosed herein. STR allows transmit and receive operations to occur simultaneously at the same RF carrier. Accordingly, STR can increase channel capacity to up to twice that of a conventional Time Division Duplexing (TDD) based and/or Frequency Division Duplexing (MD) based channel because the downlink (DL) and uplink (UL) channels share the same RF carrier both in time and in frequency resources. In one exemplary embodiment, the network infrastructure (i.e., the base station (BS), enhanced NodeB (eNB), femtocell, etc.) implements simultaneous transmit and receive according to the subject matter disclosed herein if a user equipment (TIE) cannot simultaneously transmit and receive at the same frequency. More specifically, FIG. 1 depicts the general temporal relationship between an exemplary portion of a downlink (DL) radio frame 100 and an exemplary portion of an uplink (UL) radio frame 150 for simultaneous transmit and receive according to the subject matter disclosed herein. Both DL radio frame 100 and UL radio frame 150 are at the same exemplary RF carrier frequency f₁. Exemplary DL radio frame 100 includes a Broadcast & Control Channel portion 101; a second portion 102 in which a DL transmission from the eNB to an exemplary UE 1 is scheduled; a third portion 103 in which a DL transmission from the eNB to an exemplary UE 2 is scheduled; a fourth portion 104 in which a DL transmission from the eNB to an exemplary UE 3 is scheduled; and a fifth portion 105 in which no DL transmission is scheduled. Exemplary UL radio frame 150 includes a first portion 151 in which no UL transmission is scheduled; a second portion 152 in which an UL transmission from UE 2 to the eNB is scheduled; a third portion 153 in which an UL transmission from UE 3 is scheduled, a fourth portion 154 in which an UL transmission from UE 1 is scheduled; and a fifth portion 155 in which an UL transmission from an exemplary UE 4 is scheduled. It should be understood that both DL radio frame 100 and UL radio frame 150 could include additional portions that are not depicted in FIG. 1 or described herein.

As depicted in FIG. 1, during the first portion 101 of DL frame 100 when the eNB transmits broadcast channel and control channel information, no UE UL transmission should be scheduled as the UEs are in a receive mode to receive scheduling and other control channel information. (If, however, a UE is STR capable, the UE can be scheduled for UL transmission). At the end of first portion 101, both DL transmissions from the eNB and UL transmissions from UEs are scheduled to occur simultaneously. Because the time for a UE to switch from a transmission mode (Tx) to a receive mode (Rx), and from Rx to Tx is generally non-zero, scheduling of DL and UL transmission for a particular UE that does not have STR capability must provide a time delay between DL and UL transmissions so that the UE has sufficient time switch between Tx to Rx modes and Rx to Tx modes. In one exemplary embodiment, a 5 μsec time delay is used for allowing a UE that does not have STR capability to switch between Tx and Rx modes and between Rx and Tx modes. In another exemplary embodiment, a time delay of less than 5 μsec could be used. In still another exemplary embodiment, the respective times to switch between Tx and Rx modes and between Rx and Tx modes are substantially the same. In yet another exemplary embodiment, the respective times to switch between Tx and Rx modes and between Rx and Tx modes differs. Additionally, because a UE may not necessarily have a STR capability, a scheduler device should avoid scheduling DL and UL packets for a particular UE that overlap both in time and carrier frequency. Alternatively, if a UE has STR capability, then a scheduler device can schedule DL and UL packets for the STR-capable UE that overlap both in time and carrier frequency.

If UE is not STR capable, FIG. 1 depicts, for example, that daring second portion 102 of DL frame 100, the eNB is transmitting a DL signal to UE 1, while simultaneously UE 2 is transmitting a UL signal to the eNB during the second portion 152 of UL frame 150. If UE 2 is not STR capable, then a time delay t₀ is added to the schedule so that UE 2 has enough time to switch from a Rx mode to a Tx mode. Also as depicted in FIG. 1, a DL transmission from the eNB to UE 2 is scheduled during third portion 103; consequently, the second portion 152 of UL frame 150 is scheduled to end with enough time t₁ for UE 2 to switch from a Tx mode to an Rx mode. During the third portion 153 of UL frame 150, UE 3 is scheduled to transmit a UL signal to the eNB. The exemplary third portion 153 is scheduled to end so that UE 3 has sufficient time t₃ to switch from the Tx mode to the Rx mode to receive the scheduled DE signal transmitted from the eNB to UE 3 during forth portion 104 of DL frame 100. Additionally, the DL signal from the eNB to UE 1 during second portion 102 of DL frame 100 is scheduled to end so that there is sufficient time t₂ for UE 1 to switch from the Rx mode to the Tx mode and transmit a UL signal to the eNB during forth portion 154 of the UL frame 150. No DL transmission is scheduled during the fifth portion 105 of DL frame 100, and during fifth portion 155 of UL frame 150, UE 4 (which for this example is located near an edge of the cell of the eNB, and thereby produces a low received signal power at the eNB) is scheduled to transmit a UL signal when no DL signal is transmitted by the eNB in order to reduce the adverse effects of interference even if UE 4 is STR capable.

For both STR-capable UE and a STR-incapable UE, during portion 102 of DL signal 100 and portion 152 of UL, signal, if the respective UL transmission from UE 2 unacceptably interferes with the UL signal for UE 1, the respective transmission for UE 1 and UE 2 could be scheduled to be at different subbands, thereby reducing the interference. Alternatively and additionally, UE 1 and UE 2 could be selected based on their relative physical positioning in the cell to reduce interference, that is, UE 1 and UE 2 could be selected to be physically far apart in the cell to reduce interference.

For FIG. 1, UE 4 was described as being located near an edge of the cell of the eNB, and thereby producing a low received signal power at the eNB; consequently, simultaneous transmit and receive may not work effectively. For situations in which a UE is physically located near an edge of a cell, and/or a received weak signal from a UE, a scheduler device may determine to not schedule any DL transmission so that UL transmissions from the UE are reliably received at the eNB. In the situation in which both the eNB and the UE are STR capable, and if the simultaneous transmit and receive is not effective because the STR-capable UE is located near an edge of the cell, the eNB and UE could operate in TDD-based mode. That is, if either device is transmitting a signal, the other device should not transmit any signal.

In an alternative exemplary embodiment, a UE comprises the capability to communicate the time delay required for the UE to switch from a Tx mode to a Rx mode and/or from a Rx mode to a Tx mode. The scheduler device associated with the eNB could use the specific time delays communicated from a UE to optimize scheduling of simultaneous transmit and receive operation during a radio frame.

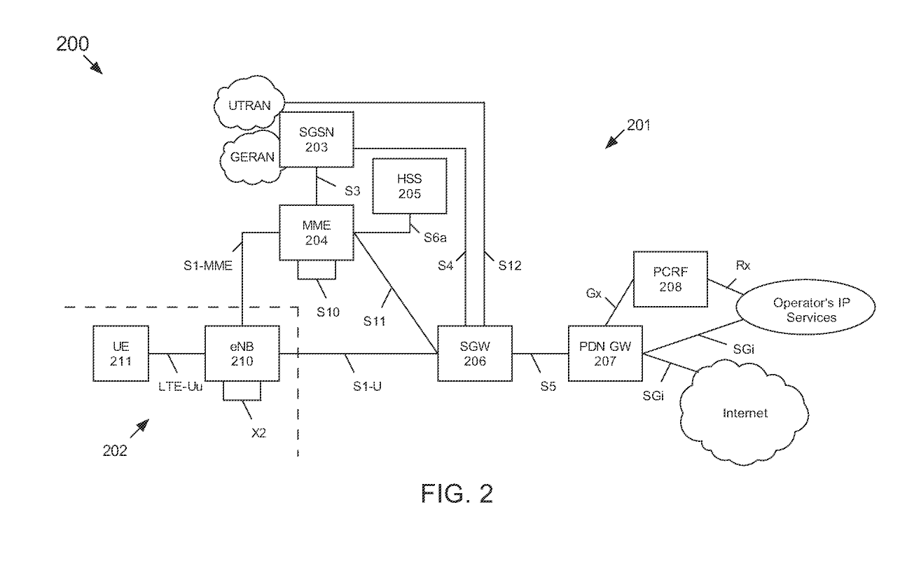

FIG. 2 shows a block diagram of the overall architecture of a Third Generation Partnership Project Long Term Evolution (3GPP LTE) network including network elements and standardized interfaces and utilizing a simultaneous transmit and receive according to the subject matter disclosed herein. At a high level, network 200 comprises a core network (CN) 201 (also referred to as the evolved Packet System (EPC)), and an air-interface access network Evolved Universal Mobile Telecommunication Service (UMTS) Terrestrial Radio Access Network (E-UTRAN) 202. CN 201 is responsible for the overall control of the various User Equipment (UE) connected to the network and establishment of the bearers. E-UTRAN 202 is responsible for all radio-related functions.

The main logical nodes of CN 201 include a Serving General Packet Radio Service (GPRS) Support Node 203, the Mobility Management Entity 204, a Home Subscriber Server (HSS) 205, a Serving Gate (SGW) 206, a Packet Data Network (PDN) Gateway 207 and a Policy and Charging Rules Function (PCRF) Manager 208. The functionality of each of the network elements of CN 201 is well known and is not described herein. Each of the network elements of CN 201 are interconnected by well-known standardized interfaces, some of which are indicated in FIG. 2, such as interfaces S3, S4, S5, etc., although not described herein.

While CN 201 includes many logical nodes, the E-UTRAN access network 202 is formed by one node, the evolved NodeB (eNB) 210, which connects to one or more User Equipment (UE) 211, of which only one is depicted in FIG. 2. For normal user traffic (as opposed to broadcast), there is no centralized controller in E-UTRAN; hence the E-UTRAN architecture is said to be flat. The eNBs are normally interconnected with each other by an interface known as “X2” and to the EPC by an S1 interface. More specifically, to Mobility Management Entity (MME) 204 by an S1-MME interface and to the SGW by an S1-U interface. The protocols that run between the eNBs and the UEs are generally referred to as the “Applicability Statement (AS) protocols.” Details of the various interfaces are well known and not described herein.

The eNB 210 hosts the PHYsical (PHY), Medium Access Control (MAC), Radio Link Control (RLC), and Packet Data Control Protocol (PDCP) layers, which are not shown in FIG. 2, and which include the functionality of user-plane header-compression and encryption. The eNB 210 also provides Radio Resource Control (RRC) functionality corresponding to the control plane, and performs many functions including radio resource management, admission control, scheduling, enforcement of negotiated Up Link (UL) Quality of Service (QoS), cell information broadcast, ciphering/deciphering of user and control plane data, and compression/decompression of DL/UL user plane packet headers.

The RRC layer in eNB 210 covers all functions related to the radio bearers, such as radio bearer control, radio admission control, radio mobility control, scheduling and dynamic allocation of resources to UEs in both uplink and downlink, scheduling of simultaneous transmission and receive, header compression for efficient use of the radio interface, security of all data sent over the radio interface, and connectivity to the EPC. The RRC layer makes handover decisions based on neighbor cell measurements sent by UE 211, generates pages for UEs 211 over the air, broadcasts system information, controls UE measurement reporting, such as the periodicity of Channel Quality Information (CQI) reports, and allocates cell-level temporary identifiers to active UEs 211. The RRC layer also executes transfer of UE context from a source eNB to a target eNB during handover, and provides integrity protection for RRC messages. Additionally, the RRC layer is responsible for the setting up and maintenance of radio bearers.

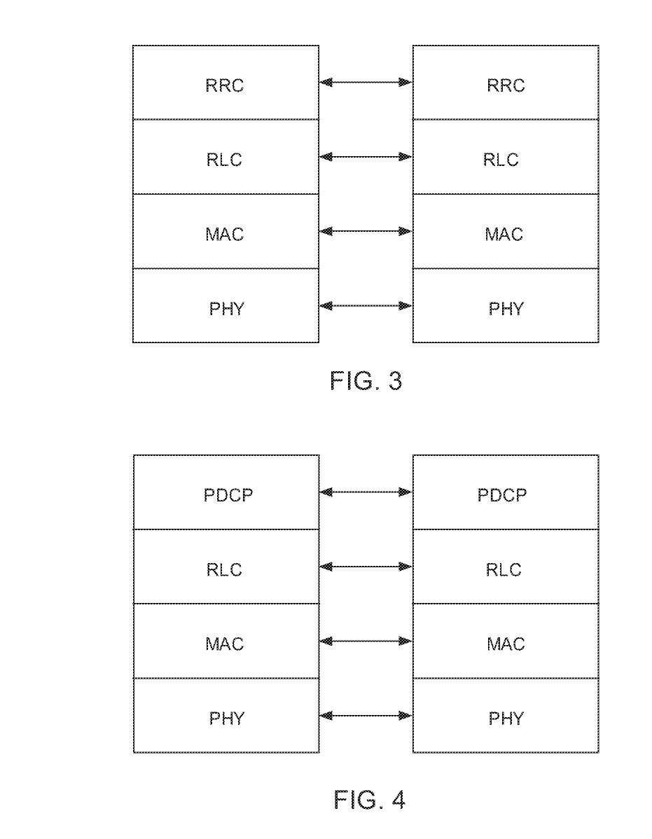

FIGS. 3 and 4 depict radio interface protocol structures between a UE and an eNodeB that are based on a 3GPP-type radio access network standard and that utilize a simultaneous transmit and receive technique in accordance with the subject matter disclosed herein. More specifically, FIG. 3 depicts individual layers of a radio protocol control plane and FIG. 4 depicts individual layers of a radio protocol user plane. The protocol layers of FIGS. 3 and 4 can be classified into an L1 layer (first layer), an L2 layer (second layer) and an L3 layer (third layer) on the basis of the lower three layers of the OSI reference model widely known in communication systems.

The physical (PHY) layer, which is the first layer (L1), provides an information transfer service to an upper layer using a physical channel. The physical layer is connected to a Medium Access Control (MAC) layer, which is located above the physical layer, through a transport channel. Data is transferred between the MAC layer and the PHY layer through the transport channel. A transport channel is classified into a dedicated transport channel and a common transport channel according to whether or not the channel is shared. Data transfer between different physical layers, specifically between the respective physical layers of a transmitter and a receiver, is performed through the physical channel.

A variety of layers exist in the second layer (L2 layer). For example, the MAC layer maps various logical channels to various transport channels, and performs logical-channel multiplexing for mapping various logical channels to one transport channel. The MAC layer is connected to the Radio Link Control (RLC) layer serving as an upper layer through a logical channel. The logical channel can be classified into a control channel for transmitting information of a control plane and a traffic channel for transmitting information of a user plane according to categories of transmission information.

The RLC layer of the second layer (L2) performs segmentation and concatenation on data received from an upper layer, and adjusts the size of data to be suitable for a lower layer transmitting data to a radio interval. In order to guarantee various Qualities of Service (QoSs) requested by respective radio bearers (RBs), three operation modes, i.e..a Transparent Mode (TM), an Unacknowledged Mode (UM), and an Acknowledged Mode (AM), are provided. Specifically, an AM RLC performs a retransmission function using an Automatic Repeat and Request (ARQ) function so as to implement reliable data transmission.

A Packet Data Convergence Protocol (PDCP) layer of the second layer (L2) performs a header compression function to reduce the size of an IP packet header having relatively large and unnecessary control information in order to efficiently transmit IP packets, such as IPv4 or IPv6 packets in a radio interval with a narrow bandwidth. As a result, only information required for a header part of data can be transmitted, so that transmission efficiency of the radio interval can be increased. In addition, in an LTE-based system, the PDCP layer performs a security function that includes a ciphering function for preventing a third party from eavesdropping on data and an integrity protection function for preventing a third party from handling data.

A Radio Resource Control (RRC) layer located at the top of the third layer (L3) is defined only in the control plane and is responsible for control of logical, transport, and physical channels in association with configuration, re-configuration and release of Radio Bearers (RBs). The RB is a logical path that the first and second layers (L1 and L2) provide for data communication between the UE and the UTRAN. Generally, Radio Bearer (RB) configuration means that a radio protocol layer needed for providing a specific service, and channel characteristics are defined and their detailed parameters and operation methods are configured. The Radio Bearer (RB) is classified into a Signaling RB (SRB) and a Data RB (DRB). The SRB is used as a transmission passage of RRC messages in the C-plane, and the DRB is used as a transmission passage of user data in the U-plane.

A downlink transport channel for transmitting data from the network to the UE may be classified into a Broadcast Channel (BCH) for transmitting system information and a downlink Shared Channel (SCH) for transmitting user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a Random Access Channel (RACH) for transmission of initial control messages and an uplink SCH for transmission of user traffic or control messages.

Downlink physical channels for transmitting information transferred to a downlink transport channel to a radio interval between the UE and the network are classified into a Physical Broadcast Channel (PBCH) for transmitting BCH information, a Physical Multicast Channel (PMCH) for transmitting MCH information, a Physical Downlink Shared Channel (PDSCH) for transmitting downlink SCH information, and a Physical Downlink Control Channel (PDCCH) (also called a DL L1/L2 control Channel) for transmitting control information, such as DL/UL Scheduling Grant information, received from first and second layers (L1 and L2). In the meantime, uplink physical channels for transmitting information transferred to an uplink transport channel to a radio interval between the UE and the network are classified into a Physical Uplink Shared Channel (PUSCH) for transmitting uplink SCH information, a Physical Random Access Channel for transmitting RACH information, and a Physical Uplink Control Channel (PUCCH) for transmitting control information, such as Hybrid Automatic Repeat Request (HARQ) ACK or NACK Scheduling Request (SR) and Channel Quality Indicator (CQI) report information, received from first and second layers (L1 and L2).

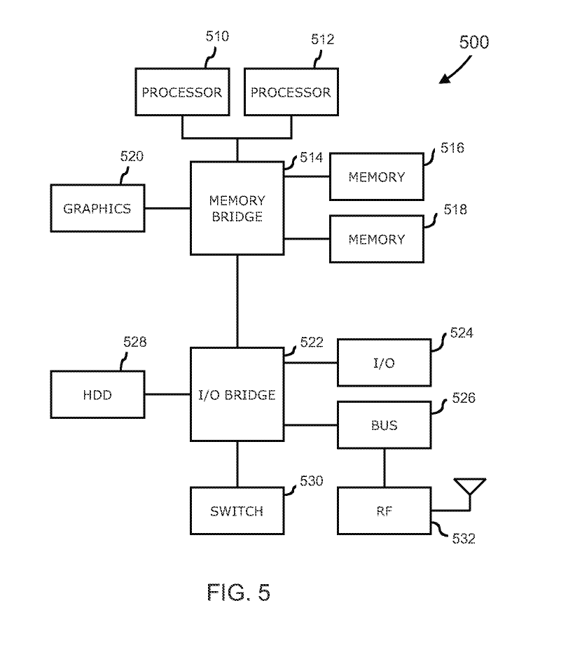

FIG. 5 depicts functional block diagram of an information-handling system 500 that utilizes a simultaneous transmit and receive technique according to the subject matter disclosed herein. Information-handling system 500 of FIG. 5 may tangibly embody one or more of any of the network elements of core network 200 as shown in and described with respect to FIG. 2. For example, information-handling system 500 may represent the hardware of eNB 210 and/or UE 211, with greater or fewer components depending on the hardware specifications of the particular device or network element. Although information-handling system 500 represents one example of several types of computing platforms, information-handling system 500 may include more or fewer elements and/or different arrangements of elements than shown in FIG. 5, and the scope of the claimed subject matter is not limited in these respects.

Information-handling system 500 may comprise one or more processors, such as processor 510 and/or processor 512, which may comprise one or more processing cores. One or more of processor 510 and/or processor 512 may couple to one or more memories 516 and/or 518 via memory bridge 514, which may be disposed external to processors 510 and/or 512, or alternatively at least partially disposed within one or more of processors 510 and/or 512. Memory 516 and/or memory 518 may comprise various types of semiconductor-based memory, for example, volatile-type memory and/or non-volatile-type memory. Memory bridge 514 may couple to a graphics system 520 (which may include a graphics processor (not shown) to drive a display device, such as a CRT, an LCD display, an LED display, touch-screen display, etc. (all not shown), coupled to information handling system 500.

Information-handling system 500 may further comprise input/output (I/O) bridge 522 to couple to various types of I/O systems, such as a keyboard (not shown), a display (not shown) and/or an audio output device (not shown), such as a speaker. I/O system 524 may comprise, for example, a universal serial bus (USB) type system, an IEEE-1394-type system, or the like, to couple one or more peripheral devices to information-handling system 500. Bus system 526 may comprise one or more bus systems, such as a peripheral component interconnect (PCI) express type bus or the like, to connect one or more peripheral devices to information-handling system 500. A hard disk drive (HDD) controller system 528 may couple one or more hard disk drives or the like to information handling system, for example, Serial ATA type drives or the like, or alternatively a semiconductor based drive comprising flash memory, phase change, and/or chalcogenide type memory or the like. Switch 530 may be utilized to couple one or more switched devices to I/O bridge 522, for example Gigabit Ethernet type devices or the like. Furthermore, as shown in FIG. 5, information-handling system 500 may include a radio-frequency (RF) block 532 comprising RF circuits and devices for wireless communication with other wireless communication devices and/or via wireless networks, such as core network 200 of FIG. 2, for example, in which information-handling system 500 embodies base station 214 and/or wireless device 216, although the scope of the claimed subject matter is not limited in this respect. In one or more embodiments, information-handling system could comprise an eNB and/or a UE that is provides simultaneous transmit and receive capability according to the subject matter disclosed herein.

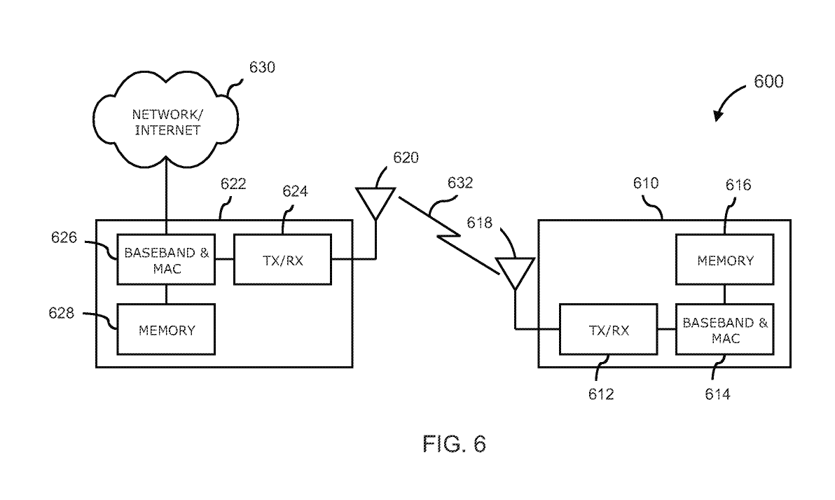

FIG. 6 depicts a functional block diagram of a wireless local area or cellular network communication system 600 depicting one or more network devices utilizing a simultaneous transmit and receive technique according to the subject matter disclosed herein. In the communication system 600 shown in FIG. 6, a wireless device 610 may include a wireless transceiver 612 to couple to one or more antennas 618 and to a processor 614 to provide baseband and media access control (MAC) processing functions. In one or more embodiments, wireless device 610 may be a UE that provides simultaneous transmit and receive capability, a cellular telephone, an information-handling system, such as a mobile personal computer or a personal digital assistant or the like, that incorporates a cellular telephone communication module, although the scope of the claimed subject matter is not limited in this respect. Processor 614 in one embodiment may comprise a single processor, or alternatively may comprise a baseband processor and an applications processor, although the scope of the claimed subject matter is not limited in this respect. Processor 614 may couple to a memory 616 that may include volatile memory, such as dynamic random-access memory (DRAM), non-volatile memory, such as flash memory, or alternatively may include other types of storage, such as a hard disk drive, although the scope of the claimed subject matter is not limited in this respect. Some portion or all of memory 616 may be included on the same integrated circuit as processor 614, or alternatively some portion or all of memory 616 may be disposed on an integrated circuit or other medium, for example, a hard disk drive, that is external to the integrated circuit of processor 614, although the scope of the claimed subject matter is not limited in this respect.

Wireless device 610 may communicate with access point 622 via wireless communication link 632, in which access point 622 may include at least one antenna 620, transceiver 624, processor 626, and memory 628. In one embodiment, access point 622 may be an eNB, an eNB having simultaneous transmit and receive scheduling capability, a RRH, a base station of a cellular telephone network, and in an alternative embodiment, access point 622 may be an access point or wireless router of a wireless local or personal area network, although the scope of the claimed subject matter is not limited in this respect, in an alternative embodiment, access point 622 and optionally mobile unit 610 may include two or more antennas, for example, to provide a spatial division multiple access (SDA) system or a multiple-input-multiple-output (MIMO) system, although the scope of the claimed subject matter is not limited in this respect. Access point 622 may couple with network 630 so that mobile unit 610 may communicate with network 630, including devices coupled to network 630, by communicating with access point 622 via wireless communication link 632. Network 630 may include a public network, such as a telephone network or the Internet, or alternatively network 630 may include a private network, such as an intranet, or a combination of a public and a private network, although the scope of the claimed subject matter is not limited in this respect. Communication between mobile unit 610 and access point 622 may be implemented via a wireless local area network (WLAN), for example, a network compliant with a an Institute of Electrical and Electronics Engineers (IEEE) standard, such as IEEE 802.11a, IEEE 802.11b, HiperLAN-II, and so on, although the scope of the claimed subject matter is not limited in this respect. In another embodiment, communication between mobile unit 610 and access point 622 may be at least partially implemented via a cellular communication network compliant with a Third Generation Partnership Project (3GPP or 3G) standard, although the scope of the claimed subject matter is not limited in this respect. In one or more embodiments, antenna(s) 618 may be utilized in a wireless sensor network or a mesh network, although the scope of the claimed subject matter is not limited in this respect.

Although the claimed subject matter has been described with a certain degree of particularity, it should be recognized that elements thereof may be altered by persons skilled in the art without departing from the spirit and/or scope of claimed subject matter. The claimed subject matter will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a transceiver; and
a processor coupled to the transceiver and being configured to schedule downlink and uplink transmissions between the transceiver and one or more wireless devices,
a first predetermined period of time being scheduled between an end of a downlink transmission to a first wireless device and a beginning of a subsequent uplink transmission from the first wireless device, and a second predetermined period of time being scheduled between an end of an uplink transmission from the first wireless device and a beginning of a subsequent downlink transmission to the first wireless device,
the transceiver being capable of receiving an uplink transmission from a second wireless device while the transceiver transmits the downlink transmission to the first wireless device, and being capable of transmitting a downlink transmission to a third wireless device while the transceiver receives the uplink transmission from the first wireless device.

2. The apparatus according to claim 1, wherein the first predetermined period of time comprises substantially the same period of time as the second predetermined period of time.

3. The apparatus according to claim 1, wherein the first predetermined period of time and the second predetermined period of time are different.

4. The apparatus according to claim 1, wherein downlink transmissions and the uplink transmissions of the wireless communication channel comprises a single carrier frequency.

5. The apparatus according to claim 1, wherein the processor is further configured to schedule downlink and uplink transmissions between the transceiver and one or more additional wireless devices, the one or more additional wireless devices being capable of receiving a downlink transmission from the transceiver device while simultaneously transmitting an uplink transmission to the transceiver device.

6. The apparatus according to claim 1, wherein the processor is further configured to schedule no downlink transmissions between the transceiver device and a wireless device based on a received signal strength received at the transceiver for an uplink transmission from the wireless device, the received signal strength of the uplink transmission being less than a predetermined received signal strength.

7. The apparatus according to claim 1, wherein the processor is further configured to schedule a downlink transmission to a fourth wireless device and a simultaneous fifth wireless device, the fourth and fifth wireless devices being located relatively far from each other within a cell.

8. The apparatus according to claim 1, wherein the apparatus comprises a base station, an eNB or a femtocell.

9. The apparatus according to claim 1, wherein at least one wireless device comprises a notebook-type computer, a tablet-type computer device, a portable or a handheld communication-type device, a reader-type device, a cellular telephone, or a personal digital assistant.

10. A method, comprising:
scheduling a beginning of an uplink transmission from a wireless device to a network transceiver device a first predetermined period of time after an end of a downlink transmission from the network transceiver device to the wireless device is scheduled, the uplink transmission and the downlink transmission comprising a same carrier frequency, and the first predetermined period of time related to a time required for the wireless device to switch from a receive mode to a transmit mode; and
scheduling a beginning a downlink transmission from the network transceiver device to the wireless device a second predetermined period of time after an end of an uplink transmission from the wireless device to the network transceiver device is scheduled, the second predetermined period of time related to a time required for the wireless device to switch from a transmit mode to a receive mode.

11. The method according to claim 10, further comprising scheduling downlink and uplink transmissions between the network transceiver device and a second wireless device, the second wireless device being capable of receiving a downlink transmission from the transceiver device while simultaneously transmitting an uplink transmission to the transceiver device.

12. The method according to claim 10, further comprising scheduling no downlink transmissions between the network transceiver device and a wireless device based on a received signal strength received at the network transceiver device for an uplink transmission from the wireless device, the received signal strength of the uplink transmission being less than a predetermined received signal strength.

13. The method according to claim 10, further comprising scheduling a downlink transmission to a fourth wireless device and a simultaneous fifth wireless device, the fourth and fifth wireless devices being located relatively far from each other within a cell of the network transceiver device.

14. The method according to claim 10, wherein the first predetermined period of time comprises substantially the same period of time as the second predetermined period of time.

15. The method according to claim 10, wherein the first predetermined period of time and the second predetermined period of time are different.

16. The method according to claim 10, wherein the network transceiver device comprises at least part of a base station, an eNB or a femtocell.

17. The method according to claim 10, wherein the wireless device comprises a notebook-type computer, a tablet-type computer device, a portable or a handheld communication-type device, a reader-type device, a cellular telephone, or a personal digital assistant.

18. A system, comprising:
a transceiver coupled to a core communications network, the transceiver device being part of a wireless radio frequency (RF) communications network; and
a scheduler device coupled to the transceiver and configured to schedule downlink and uplink transmissions between the transceiver and one or more wireless devices,
the scheduler device scheduling a first predetermined period of time between an end of a downlink transmission to a first wireless device and a beginning of a subsequent uplink transmission from the first wireless device, and scheduling a second predetermined period of time between an end of an uplink transmission from the first wireless device and a beginning of a subsequent downlink transmission to the first wireless device, the downlink transmissions and the uplink transmissions of the wireless communication channel comprising a single carrier frequency of the wireless RF communications network,
the transceiver being capable of receiving an uplink transmission from a second wireless device while the transceiver transmits the downlink transmission to the first wireless device, and being capable of transmitting a downlink transmission to a third wireless device while the transceiver receives the uplink transmission from the first wireless device.

19. The system according to claim 18, wherein the first predetermined period of time comprises substantially the same period of tune as the second predetermined period of time.

20. The system according to claim 18, further comprising a display comprising an LCD display, an LED display, a touch-screen display, or combinations thereof.
